(19) United States
(12) Patent Application Publication
(10) Pub. No.: US 2007/0268304 A1
(43) Pub. Date: Nov. 22, 2007

(54) Gradient Brush and Stroke

(75) Inventor: Siu Chi Hsu, Hong Kong (CN)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/419,550

(22) Filed: May 22, 2006

(51) Int. Cl. G09G 5/02

(52) U.S. Cl. 345/592

(57) ABSTRACT

Technology and methods for creating a gradient brush including determining a shape of a brush tip of the gradient brush by defining a transparency mask in the shape of the brush tip, and defining a gradient usable to tint each individual stamp formed by the transparency mask being stamped onto a target image surface. Also technology and methods for generating a gradient brush stroke including selecting a transparency mask, selecting a gradient, stamping the transparency mask two or more times onto a target image surface proximate a trail of the gradient brush stroke wherein two or more stamps are formed, and tinting each individual stamp with the gradient independent of the other stamps.

### BACKGROUND

Many electronic graphics design applications allow a user to paint one or more brush strokes with a paintbrush tool. A typical graphics design application generates the effect of a real-world paint brush using a rubber-stamp process. For example, a tip of the brush provides the outline of a single stamp. As the user indicates the brush stroke trail, a stamp defined by the brush tip is repeatedly applied or “stamped” along the trail and filled or “tinted” with the indicated coloring to create the appearance of a brush stroke. There are also other non-rubber stamp based methods, e.g. a watercolor diffusion simulation or a skeleton based stroking process, for generating the appearance of paint brush strokes on digital surfaces.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Graphics design applications typically provide one or more digital brushes, with different brushes having different painting characteristics, such as smoothness, graininess, splattering, color, brush shape variability and other attributes that allow users to create brush marks with different expressions. It is desirable to have as many brush choices available to users as possible and that such brushes are user definable with various brush and/or painting properties, such as brush tip shape, color, opacity and the like, typically adjustable by the user. The present examples provide for creating a gradient brush and generating a gradient brush stroke. The present examples include selecting a transparency mask and a gradient to create a gradient brush, and using the transparency mask to represent the shape of a brush tip and stamping the transparency mask onto a workspace along the trail of a brush stroke, typically as it is being formed. As each stamp is formed it is filled or “tinted” individually or separately from any other stamp(s) with a selected gradient to form a gradient brush stroke.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIGS. 1A through 1H show several example transparency mask illustrations that each define example brush shapes.

FIG. 1A shows an example transparency mask providing for an example circular brush tip shape.

FIG. 1B shows an example transparency mask providing for an example triangular brush tip shape.

FIG. 1C shows an example transparency mask providing for an example six-sided star brush shape.

FIG. 1D shows an example transparency mask providing for an example cross brush tip shape.

FIG. 1E shows an example transparency mask providing for an example brush tip shape composed of multiple circles, such as circle, oriented in a somewhat random pattern, analogous to larger brush bristles.

FIG. 1F shows an example transparency mask providing for an example pair of triangles as the brush tip shape.

FIG. 1G shows an example transparency mask providing for an example brush tip composed of three different shapes.

FIG. 1H shows an example transparency mask providing for an example horizontally-oriented arrow brush tip shape.

FIGS. 2A through 2E show example gradients usable for tinting stamps of a brush stroke.

FIG. 2A show an example linear gradient.

FIG. 2B shows an example radial gradient.

FIG. 2C shows an example diamond gradient.

FIG. 2D shows an example reflected gradient.

FIG. 2E shows an example conical gradient.

FIGS. 3A through 3E show example brush stroke trails along with transparency mask stampings at various example intervals along the trails.

FIG. 3A shows an example brush stroke trail indication with the stroke beginning at the lower left and ending at the upper right.

FIG. 3B shows three example stamps, each stamp drawn end-to-end illustrating one example spacing of transparency mask stamps along a bush stroke trail.

FIG. 3C shows three example stamps, each drawn approximately equidistant apart along the brush stroke trail, forming a dotted-line style stroke pattern.

FIG. 3D shows multiple overlapping example stamps, along the brush stroke trail, forming a somewhat smooth brush stroke.

FIG. 3E shows five example stamps, each stamp drawn at a random distance along the brush stroke trail.

FIG. 4 shows an example conventional brush stroke with a gradient applied over the entire stroke.

FIG. 5 shows an example gradient brush stroke of the present invention wherein the gradient is applied to each stamp individually or separately from any other stamp(s) rather than to all stamps of the entire stroke.

FIG. 6 is a block diagram showing an example method for creating a gradient brush and generating a gradient brush stroke.

FIGS. 7A through 7D show various example gradient orientations in example stamps along a gradient brush trail.

FIG. 7A shows an example brush stroke trail including three example circular stamps, each stamp tinted with a gradient oriented in the same direction—the darker portion of the gradient toward the top and the lighter portion toward the bottom of the stamp.

FIG. 7B shows an example brush stroke trail including three example circular stamps, each stamp tinted with a gradient that is oriented in a random direction.

FIG. 7C shows an example brush stroke trail including two example triangular stamps, each stamp tinted with a gradient oriented tangentially to the brush stroke trail.

FIG. 7D shows an example brush stroke trail including three example circular stamps, each stamp tinted with a different or varying gradient.

FIG. 8 is a block diagram showing an example computing environment in which the technology and methods described herein may be implemented.

Like reference numerals are used to designate like parts in the accompanying drawings.

### DETAILED DESCRIPTION

The detailed description provided below in connection with the appended drawings is intended as a description of the present invention and is not intended to represent the only forms in which the present invention may be constructed or utilized. The description sets forth the functions of examples of the invention and the sequence of steps for constructing and operating the examples. However, the same or equivalent functions and sequences may be accomplished by different examples.

Although the present examples are described and illustrated herein as being implemented in a graphical design and computing system, the system described is provided as an example and not a limitation. As those skilled in the art will appreciate, the present examples are suitable for application in a variety of different types of systems.

Although not required, the present examples are described in the general context of computer-executable instructions, such as program modules, being executed by one or more computers or other devices. Generally, program modules include routines, programs, objects, components, data structures, etc., that perform particular tasks or implement particular abstract data types. Typically, the functionality of the program modules may be combined or distributed as desired in various environments.

In one example, a graphics data application may provide a graphics data manipulation environment for manipulating graphics data such as pixel data, vector object data, and/or any other type of graphics data. The graphics environment may provide any one or more of a graphic manipulation frame, graphics data editing tools, and the like. For example, a graphics data application may provide a “workspace” or “target image surface” for creation and/or modification (i.e., manipulation) of graphics data including brush strokes.

To allow manipulation of graphics data, a graphics design application may provide one or more graphics data editing tools and functionalities such as a tool bar, toolbox, and/or palette which are tailored for creating and editing graphics data. Such a toolbox or the like may provide one or more selectable tools to generate and/or modify graphics data. One such tool is a brush tool which may allow a user to paint pixels or marks within the workspace over a brush stroke trail. Such a trail may be defined in any appropriate manner, such as with a pen, stylus, or mouse indicator being dragged across the workspace. The trail may be defined with a pen down (stroke-begin), pen movement (stroke), and pen up event (stroke-end) or the like, which may include click-hold, movement, and click-release events respectively and may vary with the type of input device used to “draw” the stroke. Such stroke-begin, stroke movement and stroke-end indications may be initiated by a user or via any other suitable means. Other methods and mechanisms for defining a brush stroke trail may alternatively be employed.

In an example graphics environment, the painting process applied by a brush tool may be defined by one or more digital brush marks being painted by the brush tool along a brush stroke trail to create the appearance of a brush stroke on a digital surface. In one example, the painting process may be a “rubber-stamp” process with brush marks (e.g., “stamp” images) stamped and tinted along the trail.

The stamps and marks, spacing of stamps, gradient tinting, and other properties of a brush typically define a brush tool. A brush tool may provide one or more properties to be applied along the brush stroke trail. The brush properties may be any suitable properties including any one or more of a brush shape, brush size range, width variability, transparency variability, spacing, opacity, color, gradient, brush base rotation, brush rotation, paint rotation, max stamp repetition, jitter, hardness, roundness, initial slant, load image, grayscale masking, image partitions, stamp mode, and the like. The brush tool properties may be organized into those properties which define the placement of marks of a brush (e.g., brush shape, brush size range, width variability, spacing, brush base rotation, brush rotation, max stamp repetition, jitter, hardness, roundness, initial slant, grayscale masking, image partitions, stamp mode, and the like) and those properties which define the appearance or property of the mark itself, such as gradient, color (such as hue, lightness, saturation), load image, transparency variability, opacity, paint thickness, and the like. The value of one or more properties may dynamically change over the trail of a brush stroke such as transparency, width, mask shape, gradient, coloring, and the like. The one or more properties of a brush may be modified in any suitable manner, such as programmatically, electronically, or by a user through menu options, a dialogue box, and the like.

A brush shape property may define the shape for the brush mark, such as oval, bristle, image, block, and the like. Options for brush shape may be provided to a user through any suitable mechanism such as through a drop down list, text input, radio buttons, and the like. A brush shape may be analogous to the tip of the brush which, in one example, may be defined by a transparency mask.

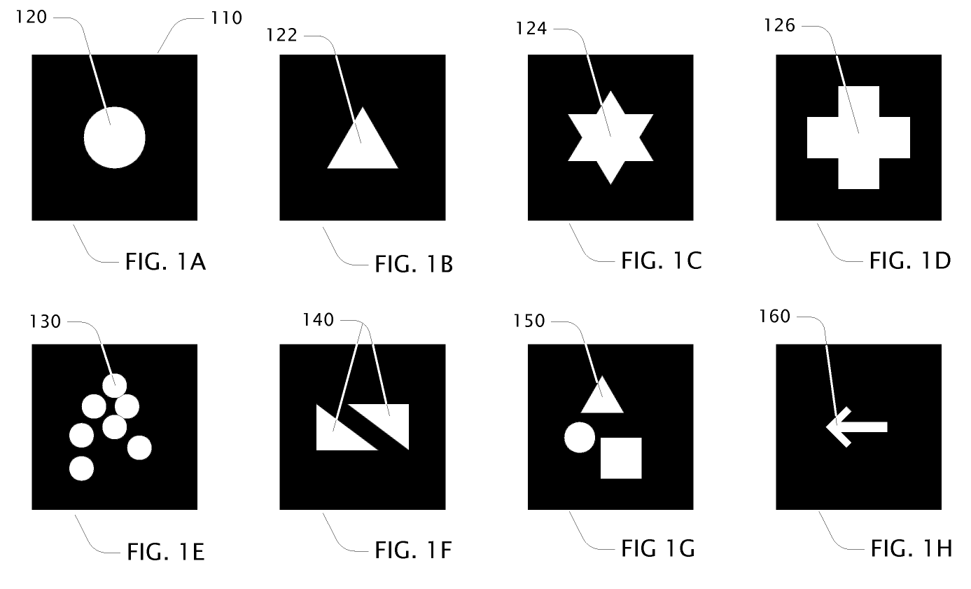

FIGS. 1A through 1H show several example transparency mask illustrations that each define example brush shapes. Any shape may be used for a transparency mask which, in one example, defines the tip of a gradient brush. The transparency mask shapes shown in FIGS. 1A through 1H are provided as examples and not by way of limitation. Each example mask is shown with a white region or shape (such as white region 120 in FIG. 1A) in a black mask area (such as example mask area 110 in FIG. 1A), the white shape defining a brush or brush tip shape in the form of a transparent region of the mask that, when stamped onto a digital surface, may be tinted with a gradient.

FIG. 1A shows an example transparency mask providing a circular brush tip shape 120.

FIG. 1B shows an example transparency mask providing a triangular brush tip shape 122.

FIG. 1C shows an example transparency mask providing a six-sided star brush shape 124.

FIG. 1D shows an example transparency mask providing a cross brush tip shape 126.

FIG. 1H shows an example transparency mask providing a horizontally-oriented arrow brush tip shape 160.

Other transparency masks may alternatively be defined to provide other brush tip shapes.

In other examples, transparency masks may include one or more composite shapes or the like, as illustrated in FIGS. 1E through 1G.

FIG. 1E shows an example transparency mask providing a brush tip shape composed of multiple circles, such as circle 130, oriented in a somewhat random pattern analogous to brush bristles.

FIG. 1F shows an example transparency mask providing a pair of triangles 140 as the brush tip shape.

FIG. 1G shows an example transparency mask providing a brush tip composed of three different shapes, including triangle 150.

Depending on the transparency mask selected, one or more other brush properties may be made available for painting. For example, given an oval brush shape, the roundness of the oval transparency mask, the angle of the non-circular brush, and/or the like may be adjusted. Given a bristle brush shape, the number of bristles (e.g., points or shapes in the transparency mask), bristle positions, and/or the like may be adjusted. Given a block brush shape, the brush may ‘paint’ a non-aliased square or block in each brush mark across the trail.

A width variability feature may determine whether the size of the brush mark depends on any one or more of a stylus pressure at a particular point in a brush stroke trail, location along the trail, location relative to a curve of the trail, and the like. If width variability is activated, the pressure or other characteristic of the user input device, such as a stylus or the like, in the workspace during creation of a trail may be used to vary brush marks to have a width proportional to or based on the pressure of the stylus on a drawing pad. If width variability is not activated, then brush marks may remain at a constant width which may be a default value and/or an indicated brush width value. A stylus is one example of a user input device that may be used to define and/or vary a brush stroke. Other input devices may also be used. Stylus pressure is one example of user device input that may affect one or more brush properties. Other examples of user device input include tilt, angle, or orientation of the input device against a drawing/painting pad or surface, speed of movement of the device against the surface, etc.

A brush size range property may define the size variability of the transparency mask responsive to one or more characteristics of an input device or the brush stroke trail itself, such as when a pressure sensitive stylus is used to draw a brush stroke trail, location along the trail, location relative to a curve of the trail, random variation, and the like. The brush size range provided by the user may be valued in any suitable manner, such as stamp width, and may define a variation in the brush mark in response to received pressure from the stylus. The size variability and range of variability of the brush size may be set in any suitable manner.

A transparency variability property may define the transparency of a mask when a pressure sensitive stylus or the like is used to define a brush stroke trail, location along the trail, location relative to a curve of the trail, and the like. For example, the transparency of the mark applied may inversely or otherwise vary relative to the pressure applied to the stylus at that point in the trail. The transparency variability may be activated in any suitable manner, such as by a user via a menu, radio button, check box, and the like.

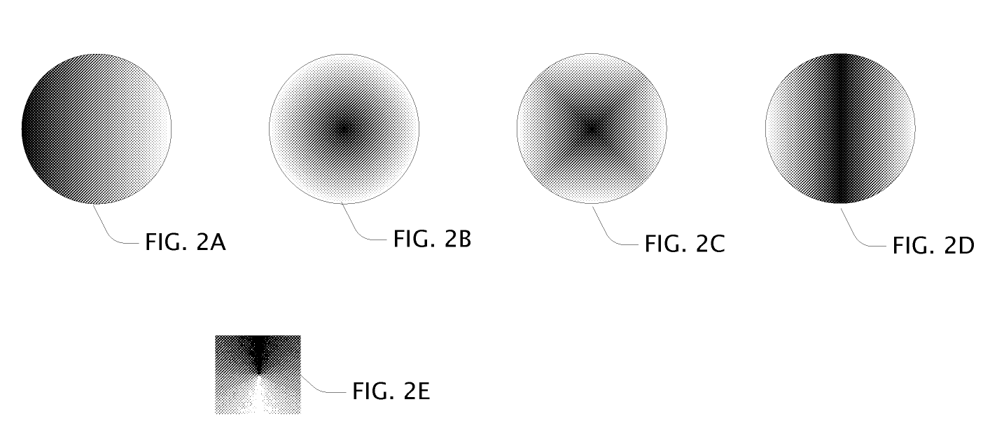

FIGS. 2A through 2E show example gradients usable for tinting stamps of a brush stroke. Example gradients are shown in black-and-white for illustrative purposes only, but may alternatively be formed using any colors or color combinations.

FIG. 2A shows an example linear gradient.

FIG. 2B shows an example radial gradient.

FIG. 2C shows an example diamond gradient.

FIG. 2D shows an example reflected gradient.

FIG. 2E shows an example conical gradient.

The example gradients shown in FIGS. 2A through 2E, or any other gradient, gradient type, or combination of gradients, may be used to tint the stamps of a brush stroke created using a transparency mask such as described herein.

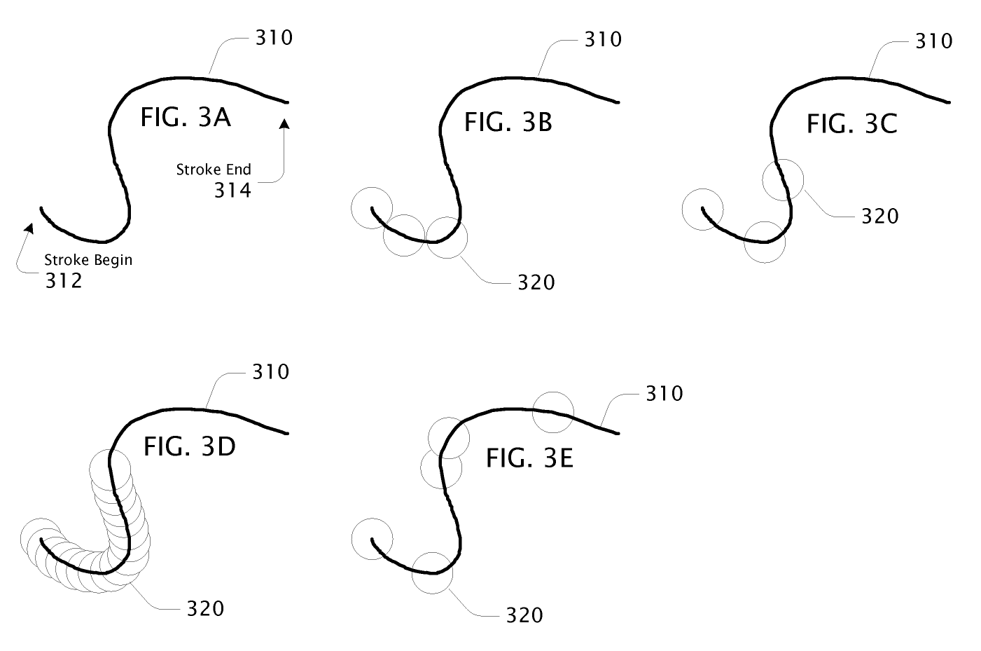

FIGS. 3A through 3E show example brush stroke trails along with transparency mask stampings at various example intervals along the trails. A circular brush shape is used simply as a matter of illustration and not limitation. Any other brush shape may alternatively be used.

FIG. 3A shows an example brush stroke trail indication 310 with the stroke beginning at the lower left 312 and ending at the upper right 314. Trail lines 310, as illustrated in FIGS. 3A through 3E, are only shown to indicate the brush stroke trail for illustration purposes; such trail lines may not be illustrated in practice. Such a trail indicates the path of a brush stroke which may take any form or shape as defined by a user or some other suitable mechanism. For purposes of illustration the entire example brush stroke trail 310 is shown. In one example, a brush stroke is generated or “painted” along a trail line, such as example trail line 310, as the trail line is defined, using brush properties including a transparency mask with gradient tinting applied to each stamp of the mask independent and separate from any other stamp(s).

FIG. 3B shows three example stamps, such as stamp 320, each stamp drawn end-to-end illustrating one example spacing of transparency mask stamps along a bush stroke trail 310.

FIG. 3C shows three example stamps, such as stamp 320, each drawn approximately equidistant apart along the brush stroke trail 310, forming a dotted-line style stroke pattern.

FIG. 3D shows multiple overlapping example stamps, such as stamp 320, along the brush stroke trail 310, forming a somewhat smooth brush stroke. When forming a gradient brush stroke each stamp will be independently and separately tinted with the gradient.

FIG. 3E shows five example stamps, such as stamp 320, each stamp drawn at a random distance from any previous stamp(s) along the brush stroke trail 310.

A gradient brush may make use of any such example stamp spacings or any other stamp spacings in generating a gradient brush stroke. A spacing property may define the spacing between the brush marks formed using stamps of the transparency mask along the indicated brush stroke trail. If the spacing is set to be close together, the stamp images are placed close together or overlap such that a smooth brush stroke effect may be achieved. If the spacing property or the like is increased, the stamps may be spaced out for a more stuttered or dashed or dotted-line effect. A random spacing or any other type of spacing may alternatively be specified. Such a spacing property may be defined and indicated in any suitable manner such as programmatically, electronically, or by a user via a user interface.

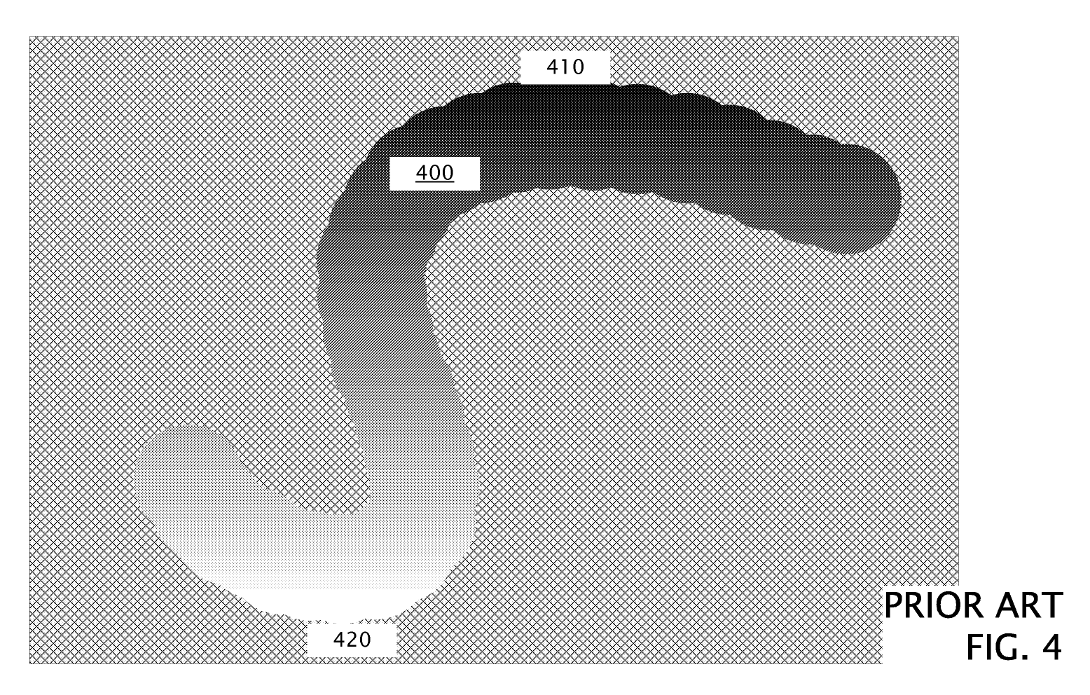

FIG. 4 shows an example conventional brush stroke with a gradient applied over the entire stroke. Conventional brush stroke 400 is shown on a hatched background only for clarity of illustration. Note that the gradient is applied to the entire brush stroke as a whole, the darker portion oriented at the top 410 of the stroke and the lighter portion at the bottom 420 of the stroke. In this manner, the stamps of a conventional brush stroke are tinted with a single gradient or gradient field, and thus, the gradient tinting each stamp is not independent or separate from that of other stamp(s). Such a gradient brush stroke with a single gradient field applied to the entire stroke as a whole is common in the art.

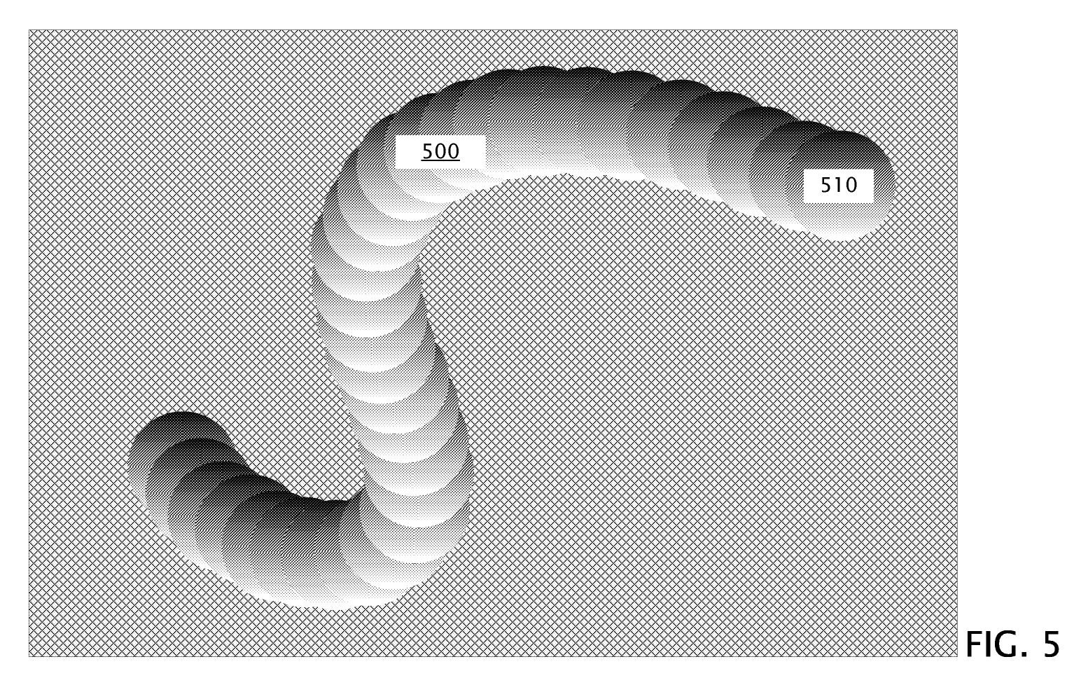

FIG. 5 shows an example gradient brush stroke of the present invention wherein the gradient is applied to each stamp individually or separately from any other stamp(s) rather than to all stamps of the entire stroke. Example gradient brush stroke 500 is shown on a hatched background only for clarity of illustration. An example gradient is applied to or tinted into each stamp, such as example stamp 510, formed by an example circular transparency mask. In example 500, the example gradient tinted into each stamp is oriented in the same example direction-darker at the top of each stamp and lighter at the bottom of each stamp. Other gradients and/or orientations may alternatively be applied to the stamps of a gradient brush stroke. By tinting each stamp individually or separately from any other stamp(s), the gradient of one stamp is considered independent or separate from the gradient of another stamp. Even so, the gradient of one stamp may “touch” or overlap or the like the gradient of another stamp, as shown in example gradient brush stroke 500.

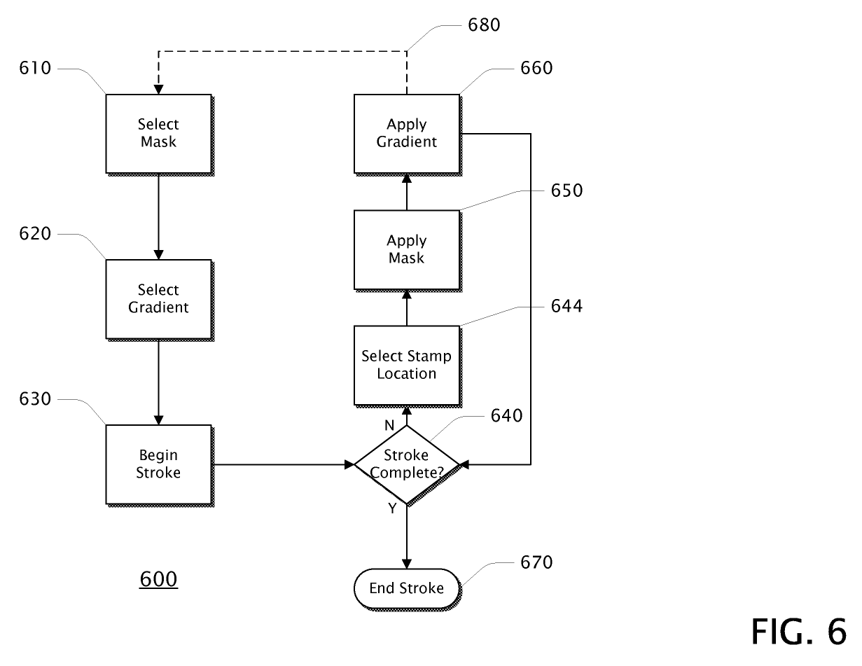

FIG. 6 is a block diagram showing an example method for creating a gradient brush and generating a gradient brush stroke. Blocks 610 and 620 generally represent the steps for creating the gradient brush.

Block 610 indicates selecting a transparency mask which typically forms the shape of the tip of the gradient brush.

Block 620 indicates selecting a gradient usable for tinting stamps proximate a brush stroke trail formed by “stamping” the transparency mask onto a workspace or target image surface.

Once a gradient brush is created, a gradient brush stroke typically begins by starting a brush stroke trail, as indicated by block 630. If the started brush stroke is not complete (block 640), then at select intervals proximate the brush stroke trail (block 644), as defined by a spacing property, user input, and/or the like, the selected transparency mask is “stamped” onto the workspace (block 650).

Once stamped onto the workspace, each stamp is individually or separately tinted with the selected gradient (block 660). In other words, each stamp is filled with the gradient separate from any other stamp(s), the background, etc. When the brush stroke is complete, the stamping and tinting are also complete (blocks 640 and 670).

Alternatively, as indicated by dotted arrow 680, a new mask and/or gradient may be selected before stamping a next stamp proximate the brush stroke trail. In this manner, a gradient tinting a stamp along the stroke may be different from previous or subsequent gradients applied to other stamp(s) in the stroke. The gradient may differ in type (e.g., a first gradient may be a conical gradient type, and a later gradient may be a radial gradient type), orientation or direction of a gradient, gradient attribute (e.g., color(s), rate of change of gradient, etc.), and the like. The transparency mask may also differ from one stamp to another.

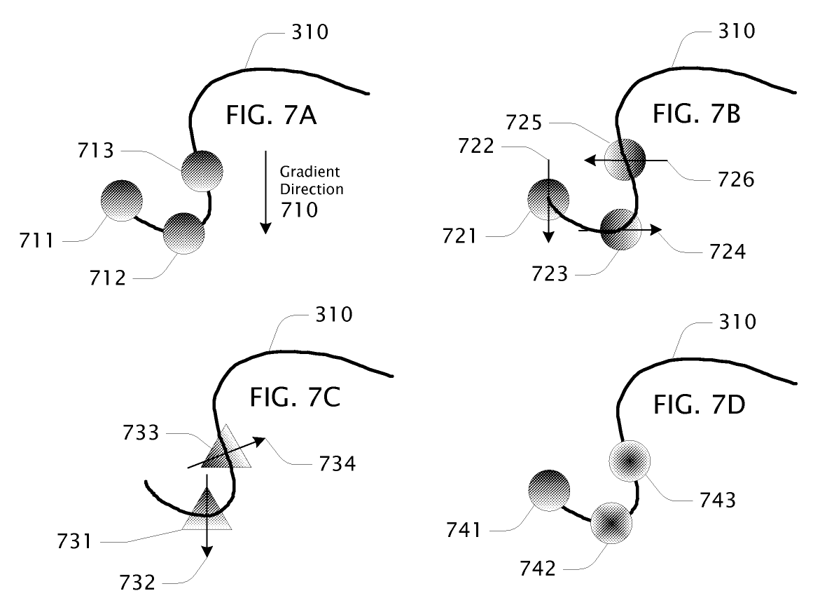

FIGS. 7A through 7D show various example gradient orientations or directions in example stamps along a gradient brush trail.

FIG. 7A shows an example brush stroke trail 310 including three example circular stamps 711-713, each stamp tinted with a gradient oriented in the same direction—the darker portion of the gradient toward the top and the lighter portion toward the bottom of the stamp—as indicated by arrow 710.

FIG. 7B shows an example brush stroke trail 310 including three example circular stamps 721, 723, 725, each stamp tinted with a gradient that is oriented in a random direction as indicated by the illustrative arrows 722, 724, 726 drawn through each tinted stamp.

FIG. 7C shows an example brush stroke trail 310 including two example triangular stamps 731 and 733, each stamp tinted with a gradient oriented tangentially to brush stroke trail 310 as indicated by the illustrative arrows 732 and 734 drawn through each stamp. Note that the brush tip shape (triangle) remains oriented the same way across the stroke (both stamps) in this example. In alternate examples, the brush tip orientation may vary from one stamp to another or in some other manner.

Other alternative gradient orientations may be applied to the stamps of a gradient brush stroke. Such orientations may be relative to a portion of the trail proximate to the stamp, may be pre-defined or user-defined, may be related or unrelated from one stamp to another, or any other gradient orientation(s) may be used in generating a gradient brush stroke.

FIG. 7D shows an example brush stroke trail 310 including three example circular stamps 741-743, each stamp tinted with a different or varying gradient.

Alternatively or additionally, the transparency mask used to create each stamp may be different or vary between stamps over the gradient brush stroke trail.

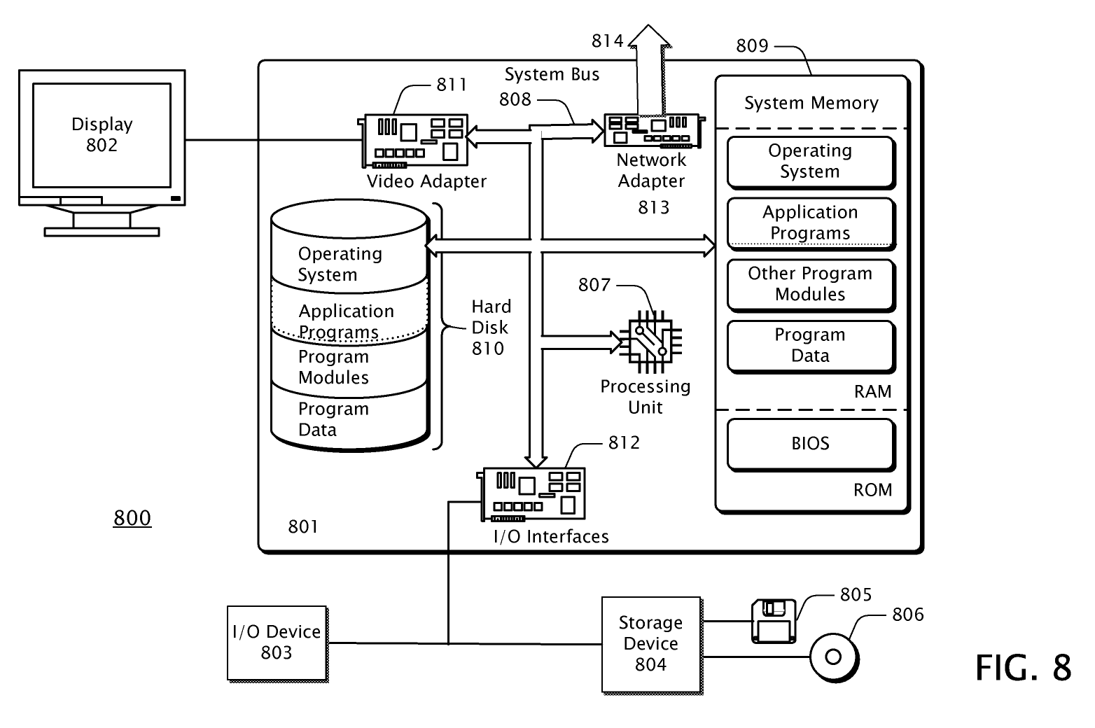

FIG. 8 is a block diagram showing an example computing environment 800 in which the technology and methods described herein may be implemented. A suitable computing environment may be implemented with numerous general purpose or special purpose systems. Examples of well known systems may include, but are not limited to, personal computers (“PC”), hand-held or laptop devices, microprocessor-based systems, multiprocessor systems, servers, workstations, consumer electronic devices, set-top boxes, and the like.

Computing environment 800 generally includes a general-purpose computing system in the form of a computing device 801 coupled to various peripheral devices 802, 803, 804 and the like. System 800 may couple to various input devices 803, including keyboards and pointing devices, such as a mouse or trackball, via one or more I/O interfaces 812. The components of computing device 801 may include one or more processors (including central processing units (“CPU”), graphics processing units (“GPU”), microprocessors (“uP”), and the like) 807, system memory 809, and a system bus 808 that typically couples the various components. Processor 807 typically processes or executes various computer-executable instructions to control the operation of computing device 801 and to communicate with other electronic and/or computing devices, systems or environment (not shown) via various communications connections such as a network connection 814 or the like. System bus 808 represents any number of several types of bus structures, including a memory bus or memory controller, a peripheral bus, a serial bus, an accelerated graphics port, a processor or local bus using any of a variety of bus architectures, and the like.

System memory 809 may include computer readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 809 typically stores data, computer-executable instructions and/or program modules comprising computer-executable instructions that are immediately accessible to and/or presently operated on by one or more of the processors 807.

Mass storage devices 804 and 810 may be coupled to computing device 801 or incorporated into computing device 801 via coupling to the system bus. Such mass storage devices 804 and 810 may include a magnetic disk drive which reads from and/or writes to a removable, non-volatile magnetic disk (e.g., a “floppy disk”) 805, and/or an optical disk drive that reads from and/or writes to a non-volatile optical disk such as a CD ROM, DVD ROM 806. Alternatively, a mass storage device, such as hard disk 810, may include non-removable storage medium. Other mass storage devices may include memory cards, memory sticks, tape storage devices, and the like.

Any number of computer programs, files, data structures, and the like may be stored on the hard disk 810, other storage devices 804, 805, 806 and system memory 809 (typically limited by available space) including, by way of example, operating systems, application programs, data files, directory structures, and computer-executable instructions. Such computer programs may include graphics design applications such as those discussed herein.

Output devices, such as display device 802, may be coupled to the computing device 801 via an interface, such as a video adapter 811. Other types of output devices may include printers, audio outputs, tactile devices or other sensory output mechanisms, or the like. Output devices may enable computing device 801 to interact with human operators or other machines or systems. A user or system may provide input to computing environment 800 via any number of different input devices or user input devices 803 including a keyboard, mouse, pen, stylus, joystick, game pad, data port, voice input device, touch input device, laser range finder, infra-read or video input device, and the like. These and other input devices may be coupled to processor 807 via input/output interfaces 812 which may be coupled to system bus 808, and may be coupled by other interfaces and bus structures, such as a parallel port, game port, universal serial bus (“USB”), fire wire, infrared port, and the like.

Computing device 801 may operate in a networked environment via communications connections to one or more remote computing devices through one or more local area networks (“LAN”), wide area networks (“WAN”), storage area networks (“SAN”), the Internet, radio links, optical links and the like. Computing device 801 may be coupled to a network via network adapter 813 or the like, or, alternatively, via a modem, digital subscriber line (“DSL”) link, integrated services digital network (“ISDN”) link, Internet link, wireless link, or the like.

Communications connection 814, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code or data maintained in an electronic device such as a ROM. The term “software” generally refers to executable instructions, code, data, applications, programs, or the like maintained in or on any form of computer-readable media. The term “computer-readable media” typically refers to system memory, storage devices and their associated media, and the like.

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

1. A method for generating a gradient brush stroke in a graphics design application, the method comprising:
defining a first transparency mask;
stamping the first transparency mask onto a target image surface proximate a trail of the gradient brush stroke;
tinting the first stamp with a first gradient;
defining a second transparency mask;
stamping the second transparency mask on the target image surface proximate the trail of the gradient brush stroke; and
tinting the second stamp with a second gradient, the second gradient being separate from the first gradient.

2. The method of claim 1 wherein the first gradient is different from the second gradient.

3. The method of claim 2 wherein an orientation of the first gradient is different than an orientation of the second gradient.

4. The method of claim 3 wherein the orientation of the first gradient is relative to a portion of the trail of the gradient brush stroke proximate to the first stamp.

5. The method of claim 4 wherein the orientation of the first gradient is tangential to the trail of the gradient brush stroke at the location of the first stamp.

6. The method of claim 2 wherein a type of the first gradient is different from a type of the second gradient.

7. The method of claim 1 wherein the first gradient or the second gradient is oriented responsive to an input generated by a user device.

8. The method of claim 1 wherein an orientation of the first gradient or the second gradient is in a pre-defined direction.

9. The method of claim 1 embodied as computer-executable instructions on computer-readable media.

10. A computer-readable medium including computer-executable instructions embodying a method for generating a gradient brush stroke, the method comprising:
selecting a transparency mask;
stamping the transparency mask onto a target image surface at a first point proximate a trail of the gradient brush stroke to form a first stamp;
tinting the first stamp with a first gradient;
after tinting the first stamp, stamping the transparency mask onto the target image surface at a second point proximate the trail of the gradient brush stroke to form a second stamp of the gradient brush stroke; and
tinting the second stamp with a second gradient.

11. The computer-readable medium of claim 10 wherein an orientation of the first gradient or the second gradient is in a pre-defined direction.

12. The computer-readable medium of claim 10 wherein an orientation of the first gradient is different than an orientation of the second gradient.

13. The computer-readable medium of claim 10 wherein an orientation of the second gradient is tangential to the trail of the gradient brush stroke proximate the second point.

14. The computer-readable medium of claim 10 wherein the first gradient or the second gradient is oriented responsive to an input of a user device.

15. The computer-readable medium of claim 14 wherein the input comprises a user device orientation relative to an input surface.

16. The computer-readable medium of claim 14 wherein the input comprises a user device pressure against an input surface.

17. The computer-readable medium of claim 14 wherein the input comprises a user device speed of movement relative to an input surface.

18. The computer-readable medium of claim 10 wherein the first gradient is of a type that is different than a type of the second gradient.

19. A method for creating a gradient brush in a graphics design application, the method comprising:
defining a transparency mask, the transparency mask usable for stamping onto a target image surface to form a first stamp and a second stamp proximate a single trail of a gradient brush stroke;
defining a first gradient usable for tinting the first stamp; and
defining a second gradient usable for tinting the second stamp, the first gradient being separate from the second gradient.

20. The method of claim 19 wherein the first gradient is different from the second gradient.
